(19) United States
(12) Patent Application Publication
(10) Pub. No.: US 2002/0182481 A1
(43) Pub. Date: Dec. 5, 2002

(54) Battery

(75) Inventor: Yukio Ehara, Kyoto-shi (JP)

Correspondence Address: SUGHRUE MION, PLLC, 2100 PENNSYLVANIA AVENUE, N.W., WASHINGTON, DC, 20037, US

(73) Assignee: GS-MELCOTEC CO., LTD.

(21) Appl. No.: 10/156,029

(22) Filed: May 29, 2002

(30) Foreign Application Priority Data
May 31, 2001 (JP) P.2001-163684

(51) Int. Cl. H01M 10/50

(52) U.S. Cl. 429/62; 429/7

(57) ABSTRACT

The battery comprises a battery main body provided with a pair of positive and negative terminals, a pair of external positive and negative terminals for connecting the pair of positive and negative terminals to an external apparatus, and a protective element provided interposed between the terminals and the external terminals, wherein the protective element is composed of a passive element alone and comprises a thermal cut-off. Further, the resistance R across the pair of external terminals is predetermined to be always greater than Vₜ/Iₜ. In this arrangement, in the case of a weak external shortcircuiting causing no battery performance deterioration, burst and ignition, the thermal cut-off can be prevented from blowing to impair the battery performance. Since proper protection of the battery is realized by the use of an inexpensive passive element alone, the production cost of the battery can be reduced.

### FIELD OF THE INVENTION

The present invention relates to a battery.

### BACKGROUND OF THE INVENTION

In general, a battery having a high energy density such as lithium secondary battery is provided with a protective circuit board for preventing the decrease in the performance of the battery or the occurrence of accidents on the battery due to overcharge or overdischarge.

FIG. 4 illustrates an exploded perspective view of a battery 100 provided with a protective circuit board 104. FIG. 5 illustrates a circuit diagram of the battery 100. The battery 100 comprises a battery main body 103 with the protective circuit board 101 mounted thereon, which is received in an outer case 102 made of synthetic resin.

The protective circuit board 101 has active elements such as IC (integrated circuit) and FET (field-effect transistor) packaged on a rectangular printed circuit board. The protective circuit board 101 is connected to the battery main body 103 via a pair of positive and negative leads 105A, 105B and a PTC (Positive Temperature Coefficient) element 106. The protective circuit board 101 has a pair of positive and negative external terminals 104A, 104B provided on the surface thereof for connecting to an external apparatus. The external terminals 104A, 104B are exposed to the exterior through the respective windows 107 provided in the outer case 102.

When the voltage of the battery 100 reaches a value beyond the predetermined value due to overcharge or overdischarge or when the battery 100 is discharged with a current exceeding the predetermined value due to external shortcircuiting or the like, IC on the protective circuit board 101 detects the current or voltage to cause FET to perform switching operation, thereby cutting the battery main body 103 off the external circuit. When the application of voltage exceeding the predetermined value or the flow of excess current is then stopped, IC detects it to cause FET to perform switching operation again, thereby restoring the connection between the external circuit and the battery main body 103.

However, the protective circuit board 101 is expensive and it requires a complicated work to mount the protective circuit board 101 on the battery main body 103, adding to the cost of the battery 100.

On the other hand, even if external shortcircuiting or other troubles occur in the case where the battery has a relatively small size and a low capacity, it is less likely that dangers such as burst and ignition can occur eventually. Thus, such a battery does not necessarily require an advanced and complicated protective mechanism such as protective circuit board 101. Therefore, a battery comprising an inexpensive passive element as a protective mechanism has been proposed. FIG. 6 illustrates a circuit diagram of such a battery 110. The battery 110 is designed to protect the battery main body 112 by a current fuse 111 instead of protective circuit board 101. When a current exceeding the predetermined fusion current value flows through the current fuse 111, the fuse element provided therein generates heat itself to blow, cutting off the circuit.

Such a small-sized low capacity battery 110 is sometimes carried in a bag, pocket, or the like. In this case, the external terminals 113A, 113B of the battery 110 can come into contact with a metallic necklace, coin, etc. to cause external shortcircuiting. The current developed by this external shortcircuiting is not so large as to cause a temperature rise which is so remarkable as to cause performance drop, ignition and burst of the battery main body 112. Nevertheless, the fuse element provided in the interior of the current fuse 111 can blow when it generates heat itself. Unlike the battery comprising the protective circuit board 101, the circuit which has been cut off by the blowing of the fuse element can never be restored even if the current due to shortcircuiting is stopped. Accordingly, although the battery main body 112 is still usable, it happens that the battery 110 must be recovered.

### SUMMARY OF THE INVENTION

The battery of the present invention is a battery comprising a battery main body provided with a pair of positive and negative terminals, a pair of external positive and negative terminals for connecting the pair of positive and negative terminals to an external apparatus, and a protective element provided interposed between the terminals and the external terminals, wherein the protective element is a passive element which comprises a thermal cut-off.

The thermal cut-off used as a protective element of the present invention generates heat as the battery undergoes overcharge, overdischarge, external shortcircuiting or the like. When the battery undergoes overcharge, overdischarge, external shortcircuiting or the like, the temperature of the battery rises beyond the predetermined value, the fuse element provided in the thermal cut-off used as a protective element of the present invention detects this heat to blow. This causes the battery main body to be cut off from the external circuit, preventing the battery main body from undergoing performance decrease, burst, ignition, etc. Thus, the use of the thermal cut-off makes it possible to protect the battery without using any expensive and complicated protective mechanism such as protective circuit board and hence reduce the production cost.

Further, unlike current fuse, etc., the thermal cut-off detects the heat generated by the battery main body to blow. Thus, the thermal cut-off does not cut off the circuit from the battery when a small shortcircuiting current flows therethrough. Accordingly, the trouble that the battery must be recovered even if the battery main body is still usable can be avoided.

As the protective element for the battery of the invention, there may be used a thermal cut-off in combination with other passive elements. However, since the single use of a thermal cut-off is sufficient to protect the battery main body, it is preferred to use the thermal cut-off singly. This can reduce the cost of parts as well as simplify the battery assembly step, making it possible to further reduce the production cost.

The fuse element provided in the thermal cut-off normally has a very low internal resistance as compared with current fuse and thus can difficultly generate heat itself when electrically energized. However, when the battery is kept shortcircuited over an extended period of time or a large current flows momentarily through the fuse element, the fuse element can possibly blow. In this case, although the battery main body is still usable, it happens that the battery must be recovered.

In order to avoid this problem, it can be proposed that a thermal cut-off having a high fusion temperature be used. However, such an arrangement is not preferable, because the circuit cannot readily cut off the battery even if the battery main body undergoes remarkable heat generation due to definite misuse such as accidental connection of the external terminals to an external power supply.

It is effective to adjust the resistance R across the external terminals so as to always follow the following relationship:

R>Vₜ/Iₜ

wherein Vₜ represents the voltage across the external terminals developed when time t elapses from the beginning of discharge the battery upon shortcircuiting; and Iₜ represents the fusion current of thermal cut-off corresponding to time t.

In this arrangement, when a slight shortcircuiting as mentioned above occurs, the shortcircuiting current (Vt/_{R}) does not exceed the fusion current (Iₜ), making it possible to prevent the thermal cut-off from blowing to impair the function of the battery. On the other hand, when the battery main body undergoes remarkable heat generation due to definite misuse, the circuit can be readily cut off, making it possible to protect the battery main body.

### BRIEF DESCRIPTION OF THE DRAWINGS

FIG. 1 is an exploded perspective view of a battery according to an embodiment of the present invention;

FIG. 2 is a circuit diagram of a battery according to an embodiments of the present invention;

FIG. 3 is a graph illustrating the fusion characteristics of a thermal cut-off;

FIG. 4 is an exploded perspective view of a conventional battery;

FIG. 5 is a circuit diagram of a conventional battery comprising a protective circuit board; and

FIG. 6 is a circuit diagram of a conventional battery comprising a current fuse.

### DETAILED DESCRIPTION OF THE INVENTION

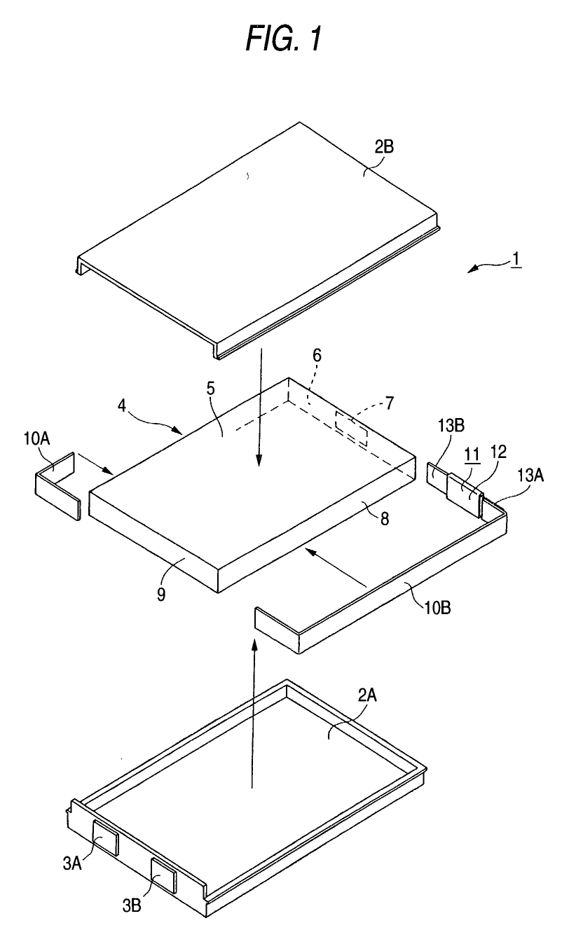

An example embodying the battery of the present invention will be described in detail in connection with FIGS. 1 to 3.

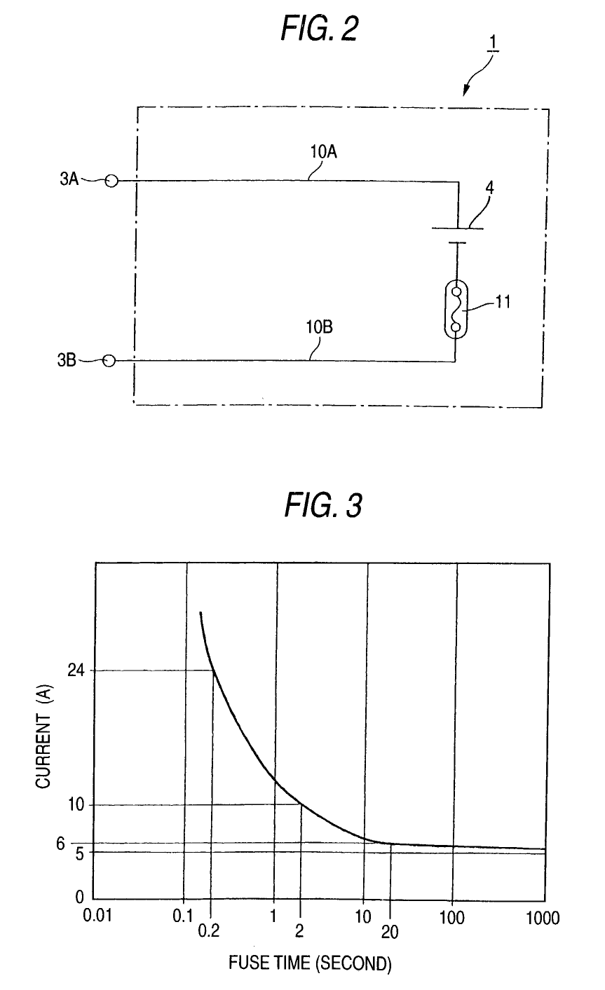

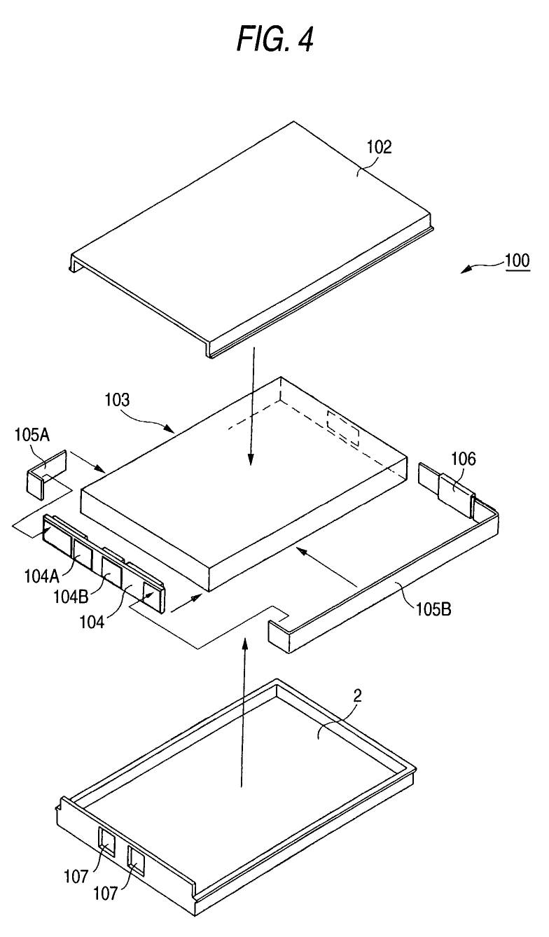

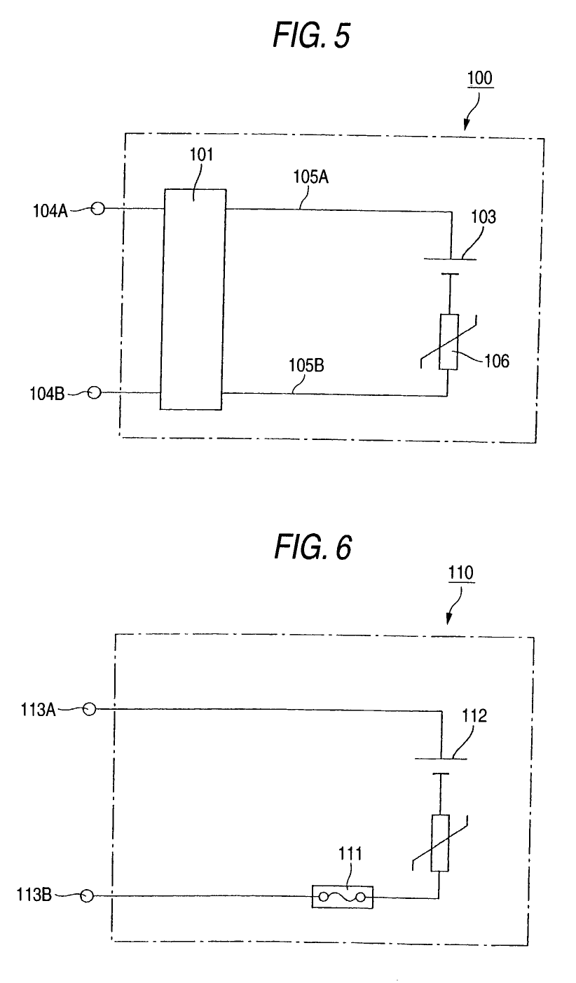

FIG. 1 illustrates an exploded perspective view of a battery 1 of the present embodiment, and FIG. 2 illustrates a circuit diagram of a battery 1 of the present embodiment. The battery 1 comprises an outer case 2 and a battery main body 4 received therein.

The outer case 2 of the battery 1 is generally in the form of a flat box comprising in combination two vertical portions having almost the same thickness, i.e., case portion 2A and cover portion 2B.

The case portion 2A is a flat box made of a polycarbonate resin which opens at the upper side thereof so as to be able to receive the battery main body 4. On the other hand, the cover portion 2B is a flat box made of a polycarbonate resin which engages with the case portion 2A so as to be able to fit onto the case portion 2A to cover the battery main body 4. The side wall of the case portion 2A and the cover portion 2B are shaped such that they can mate with each other. The two mating parts are ultrasonically welded to each other. The case portion 2A is provided with a pair of external terminals 3A, 3B on the side wall thereof for connecting the battery 1 to an external apparatus.

The battery main body 4 to be received in the outer case 2 is a prismatic lithium secondary battery. The battery main body 4 comprises a battery can 5 in the form of closed-end prismatic container made of aluminum. The battery can 5 has an electricity-generating element received therein and an electrolyte injected therein. The opening portion of the battery can 5 is covered by a cover portion 6 so that it is sealed. The cover portion 6 has a negative terminal 7 fixed thereto with an insulating packing.

Though not shown in detail, the electricity-generating element is prepared by spirally winding long belt-shaped positive electrode and negative electrode having an active material layer formed on both sides thereof with a separator interposed therebetween. The positive electrode has a positive electrode lead drawn therefrom. The positive electrode lead is needle-caulked to a current collecting washer welded to the cover portion of the battery can. In this arrangement, the battery can generally acts as a positive terminal. On the other hand, the negative electrode has a negative electrode lead drawn therefrom. The negative electrode lead is needle-caulked to the current collecting washer of the negative terminal.

The battery main body 4 is received in the outer case 2 with the bottom 9 thereof opposed to the external terminals 3A, 3B. The battery can 5 which acts as a positive terminal and the negative terminal 7 are connected to the external terminals 3A and 3B, respectively, through a lead portion 10.

The lead portion 10 is composed of a short positive lead 10A and a long negative lead 10B. The positive lead 10A has an L-shaped form obtained by bending a strip of nickel plate punched out of nickel plate. The positive lead 10A is provided along the corner extending from the side face 8 to the bottom 9 of the battery main body 4. The positive lead 10A is welded to the battery can 5 at the end thereof on the side face 8 and to the external terminal 3A at the end thereof on the bottom 9.

On the other hand, the negative lead 10B has a generally U-shaped form obtained by bending a long strip of nickel plate punched out of nickel plate with the both ends thereof opposed to each other. The negative lead 10B is welded to the battery can 5 with an insulating adhesive tape (not shown) interposed therebetween with the central portion thereof extending along the side face 8 of the battery main body, one end thereof extending along the bottom 9 and the other extending along the cover portion 6. The end portion of the negative lead 10B on the bottom 9 of the battery main body 4 is welded to the other external terminal 3B.

A thermal cut-off 11 is provided interposed between the negative lead 10B and the negative terminal 7. The thermal cut-off 11 comprises a main body 12 provided with fuse element made of a low melting metal which blows at a temperature of 95° C. and a lead wire 13 drawn respectively from the both ends of the main body 12. The thermal cut-off 12 is provided in close contact with the cover portion 6 of the battery main body 4. A lead wire 13A and a lead wire 13B are welded to the negative lead 10B and the negative terminal 7, respectively.

The thermal cut-off 11 is essentially designed to detect the heat developed when the temperature of the battery main body 4 reaches the fusion temperature and blow the fuse element so that the circuit is cut off. However, when shortcircuiting occurs across the external terminals 3A, 3B to cause the flow of weak current, the fuse element generates heat itself to blow even if the temperature of the battery main body 4 does not yet reach the fusion temperature of the thermal cut-off 11. FIG. 3 is a graph illustrating the fusion characteristics of the thermal cut-off 11 developed when it is in an atmosphere of 40° C. The thermal cut-off 11 does not blow even when a current of 5 A or less flows therethrough for a long period of time but blows when a current of 6 A flows therethrough for 20 seconds or more. In other words, the fusion current I₂₀, which corresponds to the energization time of 20 seconds, is 6 A. Further, the fusion current I₁₀, which corresponds to the energization time of 10 seconds, is 10A, and the fusion current I_{0.2}, which corresponds to the energization time of 0.2 seconds, is 24A. As the ambient temperature rises, the fusion curve-goes down leftward in the graph, showing that the fusion current It per energization time decreases and the current with which the thermal cut-off does not blow after a prolonged energization lowers.

In the battery 1, the resistance R across the external terminals 3A, 3B is adjusted to be always greater than Vₜ/Iₜ to prevent the fuse element from blowing due to heat generation. In some detail, the thickness and width of the negative lead 10B are reduced to raise the resistance R. However, if the resistance R is too great, it is difficult to secure the properties required for the battery 1. Therefore, the thickness and width of the negative lead 10B are preferably adjusted such that the resistance R is not greater than required.

The operation and effect of the invention having the aforementioned constitution will be described hereinafter.

When the battery 1 is in normal use, the temperature in the battery main body 4 is kept in a normal range. At this point, the current flows normally through the battery 1 without being restricted by the thermal cut-off 11.

On the other hand, when an excess current is suddenly applied to the circuit, e.g., when the external terminals 3A, 3B of the battery 1 are accidentally connected to an external power supply, an abnormal temperature rise occurs in the battery main body 4. The resulting heat is then transferred to the thermal cut-off 11 provided in close contact with the battery main body 4. When the-temperature of the battery main body 4 then rises beyond 95° C., the fuse element in the thermal cut-off 11 blows to cut the circuit off the battery. In this manner, the battery main body 4 can be prevented from undergoing performance deterioration, burst, ignition, etc.

When the battery 1 is carried in, e.g., a bag or pocket, the external terminals 3A, 3B can come in contact with a metallic necklace, coin, etc. to cause external shortcircuiting. Even in this case, the resulting shortcircuiting current is not large enough to cause any abnormal temperature rise in the battery main body 4. Further, since the resistance R across the external terminals 3A, 3B is adjusted to be always greater than Vₜ/Iₜ, the fuse element does not blow due to heat generation. Thus, in the case of a weak external shortcircuiting causing no battery performance deterioration, burst and ignition, the thermal cut-off 11 can be prevented from blowing to impair the battery performance.

Further, since proper protection of the battery 1 is realized, by the single use of the thermal cut-off 11 which is an inexpensive passive element, the production cost of the battery 1 can be reduced.

The technical scope of the invention is not limited to the aforementioned example. For example, the following constitutions are included in the technical scope of the invention.

(1) While the aforementioned example has been described with reference to the case where the resistance R across the external terminals 3A, 3B is adjusted by the thickness or width of the negative lead 10B, the method for adjusting the resistance R is not limited to the aforementioned example. For example, the resistance R may be adjusted by interposing a resistive element having a proper resistance between the external terminals and the lead portion.

(2) While the aforementioned example has been described with reference to the case where the thermal cut-off 11 is provided between the negative lead 10B and the negative terminal 7, the position at which the passive element is disposed is not limited to the aforementioned example. For example, the passive element may be provided between the positive lead and the terminals.

(3) While the aforementioned has been described with reference to the case where as the thermal cut-off 11 there is used one having a fusion temperature of 95° C., the fusion characteristics of the thermal cut-off to be selected is not limited to the aforementioned example. For example, the fusion characteristics of the thermal cut-off may be predetermined according to the performance of the battery or the working atmosphere.

While the invention has been described in detail and with reference to specific embodiments thereof, it will be apparent to one skilled in the art that various changes and modifications can be made therein without departing from the scope thereof.

This application is based on Japanese patent application No. 2001-163684 filed May 31, 2001, the entire contents thereof being hereby incorporated by reference.

What is claimed is:

1. A battery comprising:
a battery main body provided with a pair of positive and negative terminals;
a pair of external positive and negative terminals for connecting the pair of positive and negative terminals to an external apparatus; and
a protective element provided interposed between the terminals and the external terminals, wherein the protective element is a passive element which comprises a thermal cut-off.

2. The battery described in claim 1, wherein as the protective element there is used a thermal cut-off.

3. The battery described in claim 1 or 2, wherein the resistance R across the pair of external terminals is represented by the following relationship:
R>Vₜ/Iₜ
wherein Vₜ represents the voltage across the external terminals developed when time t elapses from the beginning of discharge of the battery upon shortcircuiting; and Iₜ represents the fusion current of thermal cut-off corresponding to time t.
